(19) United States
(12) Patent Application Publication
(10) Pub. No.: US 2021/0250409 A1
(43) Pub. Date: Aug. 12, 2021

(54) Handling of Multi-Access PDU Session Upgrade

(71) Applicant: MEDIATEK INC., Hsin-Chu (TW)

(72) Inventor: Chien-Chun Huang-Fu, Hsin-Chu (TW)

(21) Appl. No.: 17/141,962

(22) Filed: Jan. 5, 2021

Related U.S. Application Data
(60) Provisional application No. 62/975,368, filed on Feb. 12, 2020.

(51) Int. Cl. H04L 29/08; H04W 76/10; H04W 60/00

(52) U.S. Cl. CPC H04L 67/147; H04W 84/042; H04W 60/005; H04W 76/10

(57) ABSTRACT

A method of handling multi-access (MA) Protocol data unit (PDU) session upgrade is proposed. An MA PDU session. uses one 3GPP access network or one non-3GPP access network at a time, or simultaneously one 3GPP access network and one non-3GPP access network. A UE may be served by a network slice if a corresponding Single Network Slice Selection Assistance Information (S-NSSAI) is included in the allowed NSSAI per Radio Access Technology (RAT) access type. In accordance with one novel aspect, a UE performs additional check on whether the S-NSSAI associated with an MA PDU session is included in the allowed NSSAI for both 3GPP and non-3GPP access types before the UE sending out a PDU session establishment request or a PDU session modification request of the MA PDU session.

### CROSS REFERENCE TO RELATED APPLICATIONS

This application claims priority under 35 U.S.C. § 119 from U.S. Provisional Application No. 62/975,368, entitled “Handling of MA PDU Session Upgrade”, filed on Feb. 12, 2020, the subject matter of which is incorporated herein by reference.

### TECHNICAL FIELD

The disclosed embodiments relate generally to wireless communication, and, more particularly, to method of handling of Multi-Access (MA) PDU session upgrade during inter-system change from 4G LTE Evolved Packet System (EPS) to 5G system (5GS).

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. The Next Generation Mobile Network (NGMN) board, has decided to focus the future NGMN activities on defining the end-to-end requirements for 5G new radio (NR) systems.

In 5G/NR, a Protocol Data Unit (PDU) session defines the association between the UE and the data and the data network that provides a PDU connectivity service. The PDU session establishment is a parallel procedure of PDN connection (bearer) procedure in 4G/LTE. Each PDU session is identified by a PDU session ID (PSI), and may include multiple QoS flows and QoS rules. Each PDU session can be established via a 5G Access Network (e.g., a 3GPP radio access network (RAN), or a non-3GPP RAN). The network/UE can initiate different PDU session procedures, e.g., PDU session establishment, PDU session modification, and PDU session release.

Operators are seeking ways to balance data traffic between mobile networks and non-3GPP access in a way that is transparent to users and reduces mobile network congestion. In 5GS, UEs that can be simultaneously connected to both 3GPP access and non-3GPP access (using 3GPP NAS signaling), thus the 5GS is able to take advantage of these multiple accesses to improves the user experience, optimizes the traffic distribution across various accesses. Accordingly, 3GPP introduced Multi-Access (MA) PDU session in 5GS. A MA PDU session uses one 3GPP access network or one non-3GPP access network at a time, or simultaneously one 3GPP access network and one non-3GPP access network. In addition, the UE and network can support Access Traffic Steering Switching and Splitting (ATSSS) functionalities to distribute traffic over 3GPP access and non-3GPP access for the established MA PDU session.

When inter-system change from EPS to 5GS, a PDN connection is transferred to a PDU session, the UE can request to upgrade the PDU session to an MA PDU session. However, the network Access Management Function (AMF) may reject the request, e.g., due to the current single-network slice selection assistance information (S-NSSAI) is not in the allowed NSSAI for both accesses. UE behavior is not defined upon receipt of the reject of the request. A solution is sought.

### SUMMARY

A method of handling multi-access (MA) Protocol data unit (PDU) session upgrade is proposed. An MA PDU session. uses one 3GPP access network or one non-3GPP access network at a time, or simultaneously one 3GPP access network and one non-3GPP access network. The UE and network can support Access Traffic Steering Switching and Splitting (ATSSS) functionalities to distribute traffic over 3GPP access and non-3GPP access for the established MA PDU session. A UE may be served by a network slice if a corresponding Single Network Slice Selection Assistance Information (S-NSSAI) is included in the allowed NSSAI per Radio Access Technology (RAT) access type. In accordance with one novel aspect, a UE performs additional check on whether the S-NSSAI provided by the UE in a PDU session establishment request message for an MA PDU session is included in the allowed NSSAI for both 3GPP and non-3GPP access types before the UE sending out a PDU session establishment request. Further, UE performs additional check on whether the S-NSSAI associated with a PDU session over 3GPP access is included in the allowed NSSAI lists for both access types before UE sending out a PDU session modification request for upgrading the single access PDU session into an MA PDU session.

In one embodiment, a UE performs registration with a Public Land Mobile Network (PLMN) over a first radio access technology (RAT) access type and a second RAT access type in a 5G system (5GS). The UE obtains a first allowed-network slice selection assistance information (NSSAI) for the first RAT access type and a second allowed NSSAI for the second RAT access type. The UE determines whether a single-NSSAI (S-NSSAI) of a protocol data unit (PDU) session belongs to the first allowed-NSSAI and the second allowed-NSSAI. The UE transmits a PDU session establishment request to establish the PDU session as a multi-access (MA) PDU session in the 5GS.

In another embodiment, a UE maintains a Packet Data Network (PDN) connection with a Public Land Mobile Network (PLMN) in an evolved packet system (EPS). The UE performs an inter-system change from the EPS to a 5G system (5GS). The PDN connection is transferred to a corresponding PDU session, and a single-network slice selection assistance information (S-NSSAI) of the PDU session belongs to a first allowed-NSSAI for a first radio access technology (RAT) access type. The UE determines whether the S-NSSAI of the PDU session belongs to a second allowed-NSSAI for a second RAT access type in the 5GS. The UE transmits a PDU session modification request to upgrade the PDU session to a multi- access (MA) PDU session in the 5GS.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G network supporting Multi-Access Protocol Data Unit (MA PDU) session establishment and upgrade upon inter-system change in accordance with one novel aspect.

FIG. 2 illustrates simplified block diagrams of a user equipment (UE) and a network entity in accordance with embodiments of the current invention.

FIG. 3 illustrates one embodiment of establishing a MA PDU session in 5GS after a UE is registered to the network over both 3GPP and non-3GPP access type belonging to the same PLMN.

FIG. 4 illustrates one embodiment of establishing a MA PDU session in 5GS after a UE is registered to the network over both 3GPP and non-3GPP access type belonging to different PLMNs.

FIG. 5 illustrates another embodiment of establishing a MA PDU session in 5GS when a UE is registered to one RAT access type and then registered to another RAT access type.

FIG. 6 illustrates the content of a URSP rule as defined in 3GPP specification, which comprises a route selection descriptor including allowed NSSAI for a RAT access type.

FIG. 7 illustrates one embodiment of MA PDU session establishment procedure with additional verification on allowed NSSAI.

FIG. 8 illustrates one embodiment of inter-system change from EPS to 5GS and MA PDU session modification procedure with verification on allowed NSSAI.

FIG. 9 is a flow chart of one method of MA PDU session establishment procedure in accordance with one novel aspect of the present invention.

FIG. 10 is a flow chart of one method of MA PDU session modification procedure in accordance with one novel aspect of the present invention.

### DETAILED DESCRIPTION

Reference will now be made in detail to some embodiments of the invention, examples of which are illustrated in the accompanying drawings.

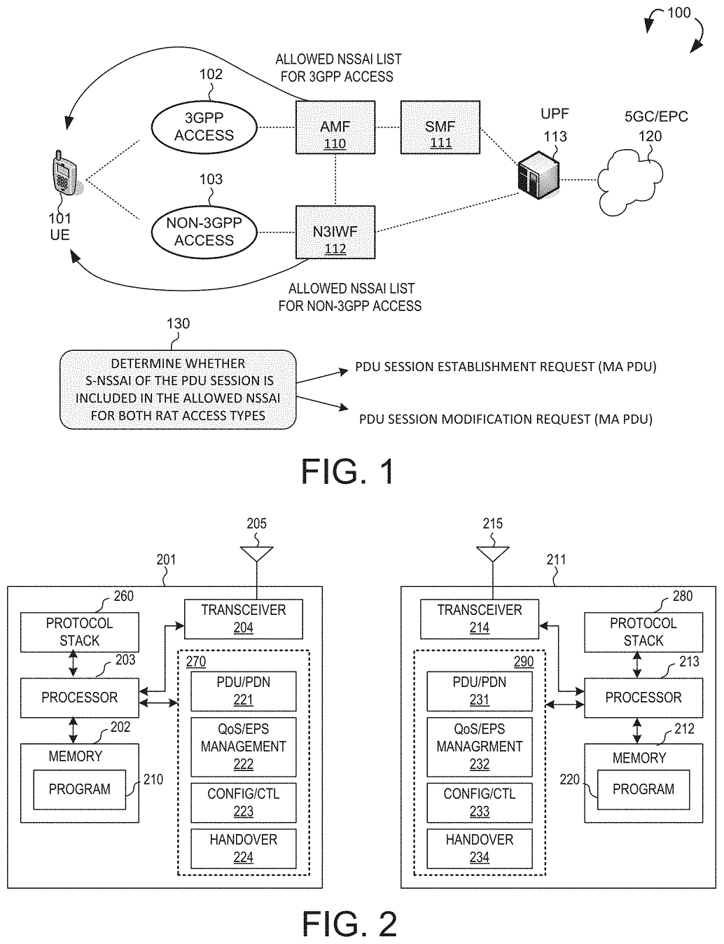

FIG. 1 illustrates an exemplary 5G network 100 supporting Multi-Access Protocol Data Unit (MA PDU) session establishment and upgrade upon inter-system change in accordance with one novel aspect. 5G new radio (NR) network 100 comprises a user equipment UE 101, a 3GPP radio access network RAN 102, a non-3GPP radio access network RAN 103, an Access and Mobility Management Function (AMF) 110, a Session Management Function (SMF) 111, an Non-3GPP Interworking Function (N3IWF) 112, a User Plane Function (UPF) 113, and a 5G core (5GC) or Evolved Packet core (EPC) data network 120. The AMF communicates with the base station, SMF and UPF for access and mobility management of wireless access devices in mobile communication network 100. The SMF is primarily responsible for interacting with the decoupled data plane, creating, updating and removing Protocol Data Unit (PDU) sessions and managing session context with the UPF. The N3IWF functionality interfaces to 5G core network control plane functions, responsible for routing messages outside 5G RAN.

In Access Stratum (AS) layer, RAN provides radio access for UE 101 via a radio access technology (RAT). In Non-Access Stratum (NAS) layer, AMF and SMF communicate with RAN and 5GC/EPC for access and mobility management and PDU session management of wireless access devices in 5G network 100. 3GPP Radio access network RAN 102 may include base stations (gNBs or eNBs) providing radio access for UE 101 via various 3GPP RATS including 5G, 4G, and 3G/2G. Non-3GPP radio access network RAN 103 may include access points (APs) providing radio access for UE 101 via non-3GPP RAT including WiFi. UE 101 can obtain access to data network 120 through 3GPP access 102, AMF 110, SMF 111, and UPF 113. UE 101 can obtain access to data network 120 through non-3GPP access 103, N3IWF 112, AMF 110, SMF 111, and UPF 113. UE 101 may be equipped with a single radio frequency (RF) module or transceiver or multiple RF modules or transceivers for services via different RATs/CNs. UE 101 may be a smart phone, a wearable device, an Internet of Things (IoT) device, a tablet, etc.

5GS networks are packet-sw_tched (PS) Internet Protocol (IP) networks. This means that the networks deliver all data traffic in IP packets, and provide users with Always On IP Connectivity. When UE joins an EPS network, Packet Data Network (PDN) address (i.e., the one that can be used on the PDN) is assigned to the TIE for its connection to the PDN. In 4G, EPS has defined a Default EPS Bearer to provide the IP Connectivity that is Always- On. In 5G, a Protocol Data Unit (PDJ) session. establishment procedure is a parallel procedure of a PDN connection procedure in 4G. A PDU session defines the association between the UE and the data network that provides a PDU connectivity service. Each PDU session is identified by a PDU session ID, and may include multiple QoS flows and QoS rules.

Each PDU session can be established over a 3GPP RAN, or over a non-3GPP RAN for radio access. 5G Session management (5GSM) for PDU sessions over both 3GPP access and non-3GPP access are managed by AMF and SMF via NAS signaling. Operators are seeking ways to balance data. traffic between mobile networks and non-3GPP access in a way that is transparent to users and reduces mobile network congestion. In 5GS, UEs that can be simultaneously connected to both 3GPP access and non-3GPP access (using 3GPP NAB signalling), thus the 5GS is able to take advantage of these mIlltiple accesses to improves the user experience, optimizes the traffic distribution across various accesses. Accordingly, 3GPP introduced Multi-Access (MA) PDU session in 5GS. A MA PDU session uses one 3GPP access network or one non-3GPP access network at a time, or simultaneously one 3GPP access network and one non-3GPP access network. In addition, the UE and the network can support Access Traffic Steering Switching and Splitting (ATSSS) functionalitles to distribute traffic over 3GPP access and non-3GPP access for the established MA PDU session.

A Network Slice is a logical network that provides specific network capabilities and network characteristics. Identification of a Network Slice is done via a Single Network Slice Selection Assistance Information (S-NSSAI). Allowed NSSAI is a collection of Single NSSAIs (S-NSSAIs). A UE may be served by a network slice if a corresponding S-NSSAI is included in the allowed NSSAI per RAT access type. When inter-system change from EPS to 5GS, a PDN connection is transferred to a PDU session, the UE can request to upgrade the PDU session to an MA PDU session. However, the network Access Management Function (AMF) may reject the request, e.g., due to the current single-network slice selection assistance information (S-NSSAI) is not in the allowed NSSAI for both access types. Furthermore, for initial PDU session establishment for an MA PDU session, the S-NSSAI provided by the UE in the PDU session establishment request message for the MA PDU session should also be included in the allowed NSSAI for both access types. In accordance with one novel aspect, as depicted in 130, UE 101 performs additional check on whether the S-NSSAI provided by the UE in the PDU session establishment request message for the MA PDU session is included in the allowed NSSAI lists for both access types before UE 101 sending out a PDU session establishment request. In addition, UE 101 performs additional check on whether the S-NSSAI associated with the PDU session over 3GPP access is included in the allowed NSSAI lists for both access types before UE 101 sending out a PDU session modification request for upgrading the single access PDU session into an MA PDU session.

FIG. 2 illustrates simplified block diagrams of wireless devices, e.g., a UE 201 and a network entity 211 in accordance with embodiments of the current invention. Network entity 211 may be a base station and/or an AMF/SMF. Network entity 211 has an antenna 215, which transmits and receives radio signals. A radio frequency RF transceiver module 214, coupled with the antenna, receives RF signals from antenna 215, converts them to baseband signals and sends them to processor 213. RF transceiver 214 also converts received baseband signals from processor 213, converts them to RF signals, and sends out to antenna 215. Processor 213 processes the received baseband signals and invokes different functional modules to perform features in base station 211. Memory 212 stores program instructions and data 220 to control the operations of base station 211. In the example of FIG. 2, network entity 211 also includes protocol stack 280 and a set of control functional modules and circuit 290. PDU session and PDN connection handling circuit 231 handles PDU/PDN establishment and modification procedures. QoS and EPS bearer management circuit 232 creates, modifies, and deletes QoS and EPS bearers for UE. Configuration and control circuit 233 provides different parameters to configure and control UE of related functionalities including mobility management and PDU session management, handover module 234 handles handover and inter-system change functionalities between 5GS and EPS.

Similarly, UE 201 has memory 202, a processor 203, and radio frequency (RF) transceiver module 204. RF transceiver 204 is coupled with antenna 205, receives RF signals from antenna 205, converts them to baseband signals, and sends them to processor 203. RF transceiver 204 also converts received baseband signals from processor 203, converts them to RF signals, and sends out to antenna 205. Processor 203 processes the received baseband signals and invokes different functional modules and circuits to perform features in UE 201. Memory 202 stores data and program instructions 210 to be executed by the processor to control the operations of UE 201. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines. A processor in associated with software may be used to implement and configure features of UE 201.

UE 201 also comprises a set of functional modules and control circuits to carry out functional tasks of UE 201. Protocol stacks 260 comprise Non-Access-Stratum (NAS) layer to communicate with an AMF/SMF/MME entity connecting to the core network, Radio Resource Control (RRC) layer for high layer configuration and control, Packet Data Convergence Protocol/Radio Link Control (PDCP/RLC) layer, Media Access Control (MAC) layer, and Physical (PHY) layer. System modules and circuits 270 may be implemented and configured by software, firmware, hardware, and/or combination thereof. The function modules and circuits, when executed by the processors via program instructions contained in the memory, interwork with each other to allow UE 201 to perform embodiments and functional tasks and features in the network.

In one example, system modules and circuits 270 comprise PDU session and PDN connection handling circuit 221 that performs PDU session and PDN connection establishment and modification procedures with the network, a QoS flow and EPS bearer handling circuit 222 that manages, creates, modifies, and deletes QoS flows and mapped EPS bearer contexts, a config and control circuit 223 that handles configuration and control parameters for mobility management and session management, and a handover module that handles handover and intersystem change. In one embodiment, UE 201 performs additional check on whether the S-NSSAI associated with an MA PDU session is included in the allowed NSSAI lists for both 3GPP and non-3GPP access types before UE 201 sending out a PDU session establishment request or a PDU session modification request of the MA PDU session.

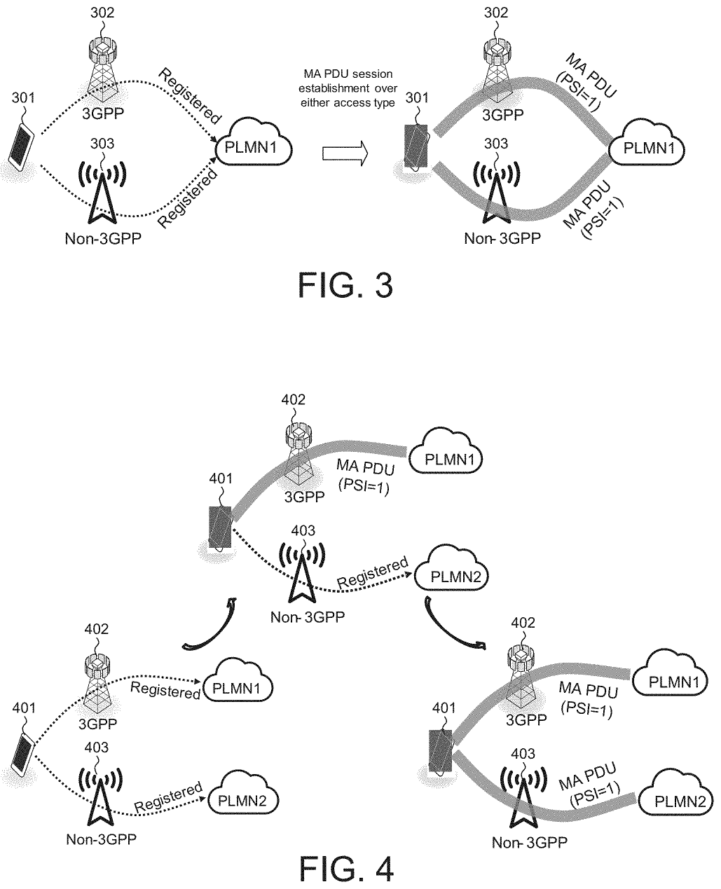

FIG. 3 illustrates one embodiment of establishing a MA PDU session in 5GS after a UE is registered to the network over both 3GPP and non-3GPP access type belonging to the same PLMN. UE 301 is registered over 3GPP access type to PLMN1 through a 3GPP base station gNB 302. UE 301 is also registered over non-3GPP access type to PLMN1 through a non-3GPP access point AP 303. UE 301 establishes a MA PDU session by initiating a PDU session establishment procedure with the network over either 3GPP or non-3GPP access type. The activation of the MA PDU connectivity service refers to the establishment of user-plane resources on both 3GPP access and non-3GPP access. Since UE 301 is registered to the network over both RAT access types belonging to the same PLMN1, the MA PDU session with PSI=1 is established over both 3GPP and non-3GPP access types, and then the user-plane resources are established over both 3GPP and non-3GPP access types.

FIG. 4 illustrates one embodiment of establishing a MA PDU session in 5GS after a UE is registered to the network over both 3GPP and non-3GPP access type belonging to different PLMNs. UE 401 is registered over 3GPP access type to a first PLMN1 through a 3GPP base station gNB 402. UE 401 is also registered over non-3GPP access type to a second PLMN2 through a non-3GPP access point AP 403. UE 401 establishes a MA PDU session by initiating a PDU session establishment procedure with the network over one of the access types, e.g., 3GPP access type. For example, UE 401 sends a PDU SESSION ESTABLISHMENT REQUEST message to gNB 402, with a request type IE set to “MA PDU request” and with PSI=1. The user plane resource on 3GPP access is then established. Next, UE 401 sends another PDU SESSION ESTABLISHMENT REQUEST message to AP 403, with a request type IE set to “MA PDU request” and with the same PSI=1. The user plane resource on non-3GPP access is then established. Since UE 401 is registered to the network over both RAT access types belonging to different PLMNs, the MA PDU session with PSI=1 is first established over 3GPP access type and then established over non-3GPP access type in two separate steps.

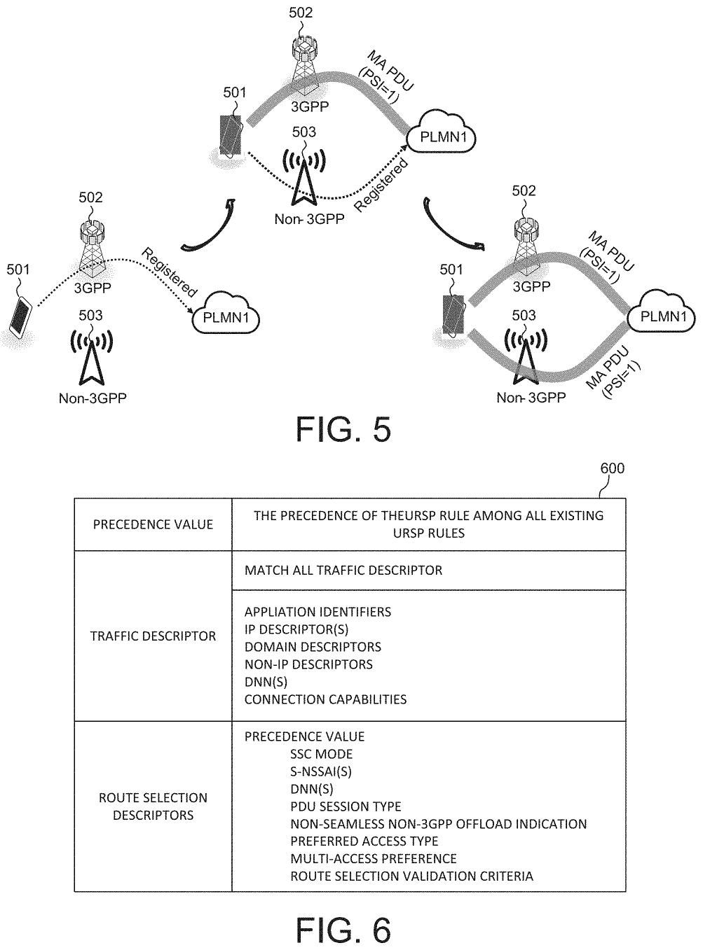

FIG. 5 illustrates another embodiment of establishing a MA PDU session in 5GS when a UE is registered to one RAT access type and then registered to another RAT access type to the same PLMN. UE 501 is registered over 3GPP access type to a first PLMN1 through a 3GPP base station gNB 502. UE 501 is not registered over non-3GPP access type to PLMN1. UE 501 then establishes a MA PDU session by initiating a PDU session establishment procedure with the network over 3GPP access type. For example, UE 501 sends a PDU SESSION ESTABLISHMENT REQUEST message to gNB 502, with a request type IE set to “MA PDU request” and with PSI=1. The user plane resource on 3GPP access is then established. Later, UE 501 is registered over non-3GPP access type to the same PLMN1 through a non-3GPP access point AP 503. UE 501 sends another PDU SESSION ESTABLISHMENT REQUEST message to AP 503, with a request type IE set to “MA PDU request” and with the same PSI=1. The user plane resource on non-3GPP access is then established. As a result, UE 501 establishes the MA PDU session to the same PLMN1 with PSI=1 over both 3GPP access type and non-3GPP access type in two separate steps.

FIG. 6 illustrates the content of a URSP rule as defined in 3GPP specification, which comprises a route selection descriptor. URSP is defined as a set of one or more URSP rules. As depicted by Table 600, each URSP rule is composed of: 1) a precedence value of the URSP rule identifying the precedence of the URSP rule among all the existing URSP rules; 2) a traffic descriptor; and 3) one or more route selection descriptors (RSDs). The traffic descriptor includes either 1) a match-all traffic descriptor; or 2) at least one of the following components: A) one or more application identifiers; B) one or more IP descriptors, i.e., IP 3 tuple including the destination IP address, the destination port number, and the protocol used above the IP; C) one or more domain descriptors, i.e., destination FQDN(s); D) one or more non-IP descriptors, i.e., destination information of non-IP traffic; E) one or more DNNs; F) one or more connection capabilities. Each route selection descriptor includes a precedence value of the route selection descriptor and optionally, one or more of the followings: A) SSC mode; B) one or more S-NSSAIs; C) one or more DNNs; D) one PDU session type; E) a non-seamless non-3GPP offload indication; F) preferred access type; G) multi-access preference; H) Route Selection Validation Criteria (RSVC).

Initially, URSP rules can be pre-configured in the UE (either in the ME or in the USIM), and the UE also needs to save the URSP rules in the NV RAM for future use. Later on, the network can update the URSP rules or provide additional URSP rules to the UE. If the route selection descriptor (RSD) of a URSP rule includes an S-NSSAI, then the UE still checks whether the S-NSSAI is included in the allowed NSSAI. If the S-NSSAI is included in the allowed NSSAI, then the UE can include this S-NSSAI in the PDU session establishment request. If the S-NNSAI is not included in the allowed NSSAI, then the UE cannot use the S-NSSAI, and the UE should select another S-NSSAI, or another RSD, or another URSP rule.

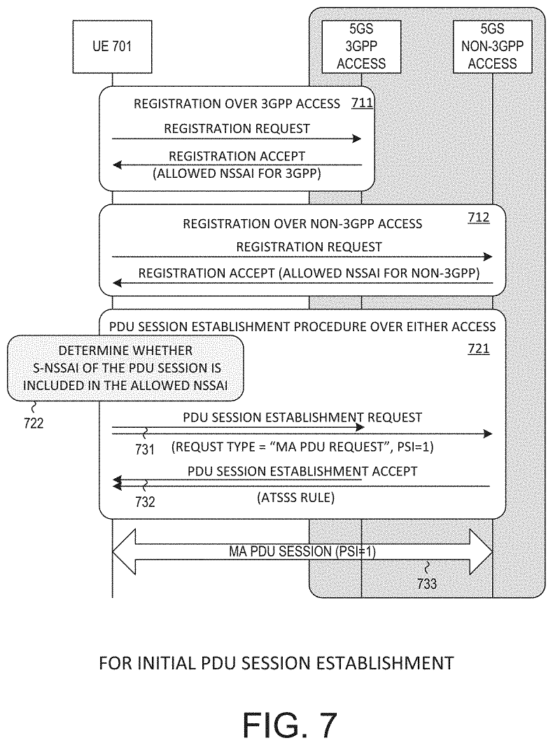

FIG. 7 illustrates one embodiment of MA PDU session establishment procedure with additional verification on allowed NSSAI. In step 711, UE 701 registers with the 5GS network over 3GPP access type. Upon sending a registration request, UE 701 receives a registration accept message from AMF of the 5GS network. The registration accept message carries a first allowed NSSAI for 3GPP access type. In step 712, UE 701 registers with the 5GS network over non-3GPP access type. Upon sending a registration request, UE 701 receives a registration accept message from AMF of the 5GS network. The registration accept message carries a second allowed NSSAI for non-3GPP access type. Optionally, UE may receive updated allowed-NSSAIs for 3GPP and/or non-3GPP access type, e.g., via a configuration update command message. The registered 5GS network may belong to the same PLMN or different PLMNs.

In step 721, UE 701 initiates a PDU session establishment procedure. In order to properly establish an MA PDU session over both 3GPP and non-3GPP access, in step 722, UE 701 performs an extra determination on whether the S-NSSAI provided by the UE in the PDU session establishment request message is included in the allowed NSSAI for both 3GPP and non-3GPP access types. If the answer is no, then UE 801 is refrained from establishing the MA PDU. If the answer is yes, then UE 701 can proceed with the PDU session establishment procedure. In step 731, UE 701 sends a PDU session establishment request message (PSI=1), along with request type IE set to “MA PDU request”, or along with MA PDU information IE set to “MA PDU session network upgrade is allowed”, over both 3GPP and non-3GPP access types. In step 732, UE 701 receives a PDU session establishment accept message with ATSSS rule and the MA PDU session (PSI=1) is established (step 733).

Note that the MA PDU session can be established under different scenarios, as illustrated earlier in FIGS. 3, 4, and 5. For example, the PDU establishment request messages over different RAT access types can be sent in two separate steps, in the same PLMN or in different PLMNs. If so, the UE needs to check whether the S-NSSAI is included in the allowed NSSAI for the second RAT access type before the UE sends the second PDU establishment request message over the second RAT access type. If not, then the UE should not include Request Type IE set to “MA PDU request” or MA PDU information IE set to “MA PDU session network upgrade is allowed” along with the second PDU establishment request message.

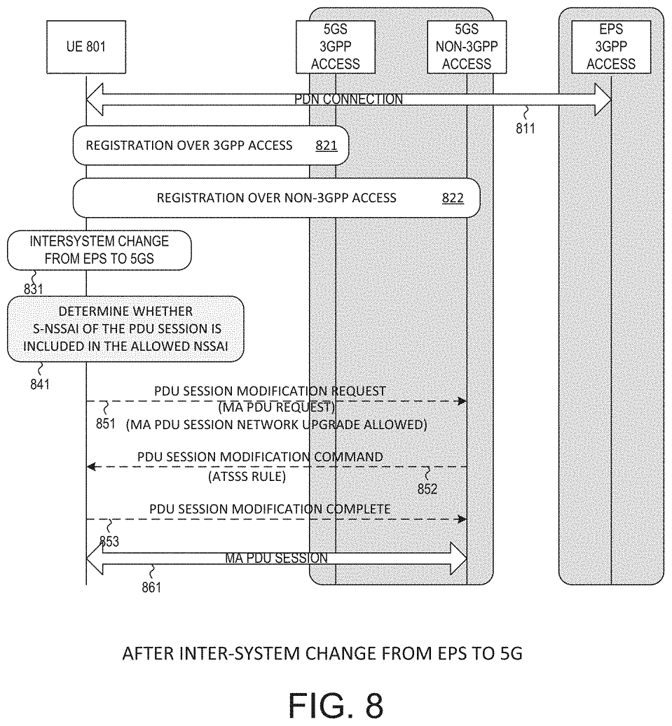

FIG. 8 illustrates one embodiment of inter-system change from EPS to 5GS and MA PDU session modification procedure with verification on allowed NSSAI. In step 811, UE 801 maintains a PDN connection in 4G EPS network over 3GPP access. The PDN connection may be established in EPS or transferred from 5GS. In step 821, UE 801 initiates mobility and periodic registration procedure with the 5GS network over 3GPP access type. Upon sending a registration request, UE 801 receives a registration accept message from AMF of the 5GS network. The registration accept message carries a first allowed NSSAI for 3GPP access type. In step 822, UE 801 registers with the 5GS network over non-3GPP access type. Upon sending a registration request, UE 801 receives a registration accept message from AMF of the 5GS network. The registration accept message carries a second allowed NSSAI for non-3GPP access type.

In step 831, UE 801 performs inter-system change from EPS to 5GS network. The established PDN connection is to be transferred to a corresponding PDU session after the completion of inter-system change. After inter-system change, the PDN connection is transferred to a single access PDU session by default. Later on, the UE can optionally upgrade it into a MA PDU session. In step 841, in order to upgrade the transferred PDU session to an MA PDU session, UE 801 needs to perform an extra determination on whether the S-NSSAI of the PDU session is included in the allowed NSSAI for both 3GPP and non-3GPP access types. If the answer is no, then UE 801 is refrained from performing the upgrade. If the answer is yes, then UE 801 can proceed with the upgrade via a PDU session modification procedure. In step 851, UE 801 sends a PDU session modification request message to the network. The request message is sent along with a Request Type IE set to “MA PDU request”, or along with an MA PDU information IE set to “ MA PDU session network upgrade is allowed”. In step 852, UE 801 receives a PDU session modification command message from the network, optionally with ATSS rule. In step 853, UE 801 sends a PDU session modification complete message to the network and complete the upgrade of the PDU session to the MA PDU session. In step 861, UE 801 communicates in the network using the MA PDU session.

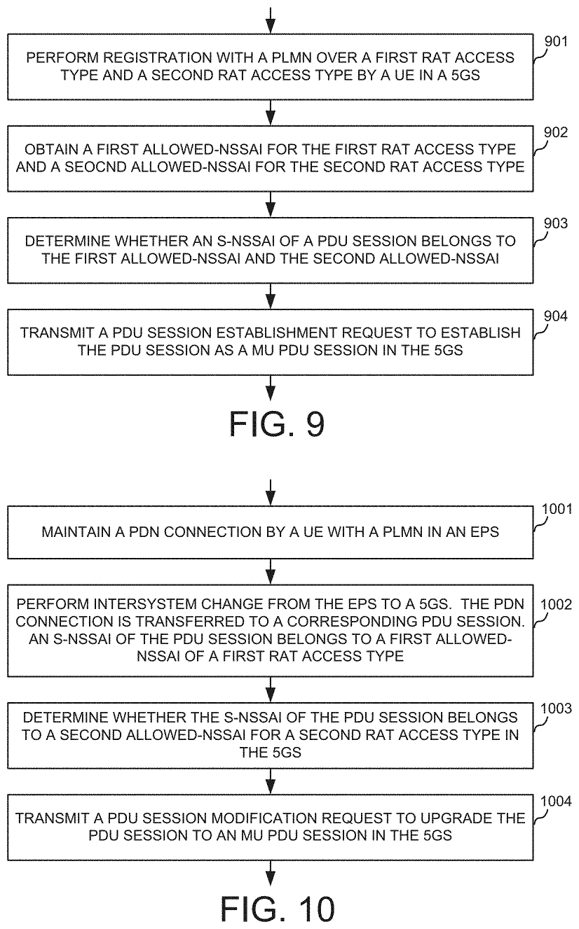

FIG. 9 is a flow chart of one method of MA PDU session establishment procedure in accordance with one novel aspect of the present invention. In step 901, a UE performs registration with a Public Land Mobile Network (PLMN) over a first radio access technology (RAT) access type and a second RAT access type in a 5G system (5GS). In step 902, the UE obtains a first allowed-network slice selection assistance information (NSSAI) for the first RAT access type and a second allowed NSSAI for the second RAT access type. In step 903, the UE determines whether a single-NSSAI (S-NSSAI) of a protocol data unit (PDU) session belongs to the first allowed-NSSAI and the second allowed-NSSAI. In step 904, the UE transmits a PDU session establishment request to establish the PDU session as a multi-access (MA) PDU session in the 5GS.

FIG. 10 is a flow chart of one method of MA PDU session modification procedure in accordance with one novel aspect of the present invention. In step 1001, a UE maintains a Packet Data Network (PDN) connection with a Public Land Mobile Network (PLMN) in an evolved packet system (EPS). In step 1002, the UE performs an inter-system change from the EPS to a 5G system (5GS). The PDN connection is transferred to a corresponding PDU session, and a single-network slice selection assistance information (S-NSSAI) of the PDU session belongs to a first allowed- NSSAI for a first radio access technology (RAT) access type. In step 1003, the UE determines whether the S-NSSAI of the PDU session belongs to a second allowed-NSSAI for a second RAT access type in the 5GS. In step 1004, the UE transmits a PDU session modification request to upgrade the PDU session to a multi-access (MA) PDU session in the 5GS.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
performing registration with a Public Land Mobile Network (PLMN) over a first radio access technology (RAT) access type and a second RAT access type by a user equipment (UE) in a 5G system (5GS);
obtaining a first allowed-network slice selection assistance information (NSSAI) for the first RAT access type and a second allowed NSSAI for the second RAT access type;
determining whether a single-NSSAI (S-NSSAI) of a protocol data unit (PDU) session belongs to the first allowed-NSSAI and the second allowed-NSSAI; and
transmitting a PDU session establishment request to establish the PDU session as a multi-access (MA) PDU session in the 5GS.

2. The method of claim 1, wherein the first or the second allowed-NSSAI is obtained via a registration accept or a configuration update command message from the PLMN.

3. The method of claim 1, wherein the PDU session establishment request is sent with a request type information element (IE) set to “MA PDU request”.

4. The method of claim 1, wherein the PDU session establishment request is sent with an MA PDU session information IE set to “MA PDU session network upgrade is allowed”.

5. The method of claim 1, wherein the UE establishes the MA PDU session over the first RAT access type and the second RAT access type in a single step.

6. The method of claim 1, wherein the UE establishes the MA PDU session over the first RAT access type and the second RAT access type in two separate steps.

7. A User Equipment (UE), comprising:
a registration circuit that performs registration with a Public Land Mobile Network (PLMN) over a first radio access technology (RAT) access type and a second RAT access type in a 5G system (5GS), wherein the UE obtains a first allowed-network slice selection assistance information (NSSAI) for the first RAT access type and a second allowed NSSAI for the second RAT access type;
a protocol data unit (PDU) session handling circuit that determines whether a single-NSSAI (S-NSSAI) of the PDU session belongs to the first allowed-NSSAI and the second allowed-NSSAI; and
a transmitter that transmits a PDU session establishment request to establish the PDU session as a multi-access (MA) PDU session in the 5GS.

8. The UE of claim 7, wherein the first or the second allowed-NSSAI is obtained via a registration accept or a configuration update command message from the PLMN.

9. The UE of claim 7, wherein the PDU session establishment request is sent with a request type information element (IE) set to “MA PDU request”.

10. The UE of claim 7, wherein the PDU session establishment request is sent with an MA PDU session information IE set to “MA PDU session network upgrade is allowed”.

11. A method, comprising:
maintaining a Packet Data Net (PDN) connection by a user equipment (UE) with a Public Land Mobile Network (PLMN) in an evolved packet system (EPS);
performing an inter-system change from the EPS to a 5G system (5GS), wherein the PDN connection is transferred to a corresponding PDU session, wherein a single-network slice selection assistance information (S-NSSAI) of the PDU session belongs to a first allowed-NSSAI for a first radio access technology (RAT) access type;
determining whether the S-NSSAI of the PDU session belongs to a second allowed-NSSAI for a second RAT access type in the 5GS; and
transmitting a PDU session modification request to upgrade the PDU session to a multi-access (MA) PDU session in the 5GS.

12. The method of claim 11, wherein the first or the second allowed-NSSAI is obtained via a registration accept or a configuration update command message from the PLMN.

13. The method of claim 11, wherein the PDU session modification request is sent with a request type information element (IE) set to “MA PDU request”.

14. The method of claim 11, wherein the PDU session modification request is sent with an MA PDU session information IE set to “MA PDU session network upgrade is allowed”.

15. The method of claim 11, wherein the first RAT is 3GPP and the second RAT is non-3GPP.

16. The method of claim 15, wherein the PDN connection is first transferred to the PDU session over 3GPP access type, and wherein the PDU session is upgraded to the MA PDU session over both 3GPP access type and non-3GPP access type upon receipt of a PDU session modification command message in response to the PDU session modification request message.

17. A User Equipment (UE), comprising:
a Packet Data Netv, (PDN) connection handling circuit that establishes a PDN connection with a Public Land Mobile Network (PLMN) in an evolved packet system (EPS);
a handover handling circuit that performs inter-system change from the EPS to a 5G system (5GS), wherein the PDN connection is transferred to a corresponding PDU session, wherein a single-network slice selection assistance information (S-NSSAI) of the PDU session belongs to a first allowed-NSSAI for a first radio access technology (RAT) access type;
a controller that determines whether the S-NSSAI of the PDU session belongs to a second allowed-NSSAI for a second RAT access type in the 5GS; and
a transmitter that transmits a PDU session modification request to upgrade the PDU session to a multi- access (MA) PDU session in the 5GS.

18. The UE of claim 17, wherein the first or the second allowed-NSSAI is obtained via a registration accept or a configuration update command message from the PLMN.

19. The UE of claim 17, wherein the PDU session modification request is sent with a request type information element (IE) set to “MA PDU request”.

20. The UE of claim 17, wherein the PDU session modification request is sent with an MA PDU session information IE set to “MA PDU session network upgrade is allowed”.
